(19) United States
(12) Patent Application Publication
(10) Pub. No.: US 2023/0064319 A1
(43) Pub. Date: Mar. 2, 2023

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Yoshimitsu Murahashi, Wako-shi (JP); Masanori Takeda, Wako-shi (JP)

(21) Appl. No.: 17/890,296

(22) Filed: Aug. 18, 2022

(30) Foreign Application Priority Data
Aug. 24, 2021 (JP) 2021-136258

(51) Int. Cl. B60W 30/095; B60W 10/20

(52) U.S. Cl. CPC B60W 30/0956; B60W 10/20; B60W 2710/20; B60W 2720/106; B60W 2554/4041; B60W 2520/06; B60W 2554/4044; B60W 2554/802; B60W 2552/53; B60W 2554/4029; G06V 20/58

(57) ABSTRACT

A vehicle control device of an embodiment includes a recognizer configured to recognize a surrounding situation of a vehicle, and a driving controller configured to execute driving control of controlling one or both of a speed and steering of the vehicle on the basis of the surrounding situation recognized by the recognizer, in which the recognizer recognizes a traffic participant present in front of the vehicle and a traffic participant priority section present in a traveling direction of the vehicle, and the driving controller sets a risk area for the traffic participant priority section on the basis of a position and a traveling direction of the traffic participant, and executes the driving control based on the set risk area and the position of the traffic participant.

### CROSS-REFERENCE TO RELATED APPLICATION

Priority is claimed on Japanese Patent Application No. 2021-136258, filed Aug. 24, 2021, the content of which is incorporated herein by reference.

### BACKGROUND

### Field of the Invention

The present invention relates to a vehicle control device, a vehicle control method, and a storage medium.

### Description of Related Art

In recent years, research has been conducted on automatically controlling the traveling of vehicles. In this regard, a technology of dividing an area of a road surface including a road and a sidewalk in a captured image by boundary lines based on a contour of a crossable area extracted from the captured image, selecting a pedestrian pattern corresponding to each of the divided areas, and recognizing a pedestrian present in the crossable area by collation using a pedestrian pattern in each area is known (for example, Japanese Unexamined Patent Application, First Publication No. 2012-190214).

### SUMMARY

However, the traveling direction of a pedestrian has not been considered in conventional technologies. For this reason, when a pedestrian was present in the crossable area, excessive driving control that was not actually necessary was executed, such as deceleration and stop control of the vehicle, even if a risk of contact between the vehicle and the pedestrian was low.

Aspects of the present invention have been made in consideration of such circumstances, and an object thereof is to provide a driving control device, a driving control method, and a storage medium capable of executing vehicle driving control based on more appropriate recognition of a traffic participant.

The driving control device, the driving control method, and the storage medium according to the present invention have adopted the following configuration.

(1): A vehicle control device according to one aspect of the present invention includes a recognizer configured to recognize a surrounding situation of a vehicle, and a driving controller configured to execute driving control of controlling one or both of a speed and steering of the vehicle on the basis of the surrounding situation recognized by the recognizer, in which the recognizer recognizes a traffic participant present in front of the vehicle and a traffic participant priority section present in a traveling direction of the vehicle, and the driving controller sets a risk area for the traffic participant priority section on the basis of a position and a traveling direction of the traffic participant, and executes the driving control based on the set risk area and the position of the traffic participant.

(2): In the aspect of (1) described above, when a distance between the vehicle and the traffic participant priority section is within a predetermined distance and there is a traffic participant in the risk area, the driving controller executes the driving control including steering control for decelerating the vehicle, stopping the vehicle, or causing the vehicle to avoid contact with the traffic participant.

(3): In the aspect of (1) described above, the traffic participant priority section includes a pedestrian crossing, and the driving controller sets different risk areas when the traffic participant enters the pedestrian crossing from a lane side where the traffic participant can travel in the same direction as the traveling direction of the vehicle and when the traffic participant enters the pedestrian crossing from an opposite lane side of the lane where the traffic participant can travel in the same direction.

(4): In the aspect of (1) described above, the traffic participant priority section includes a pedestrian crossing, and the driving controller sets an area including an area from an end of the pedestrian crossing on a side where the traffic participant enters to a position beyond a traveling lane of the vehicle as the risk area.

(5): In the aspect of (1) described above, the driving controller switches a risk area on the basis of the position of the traffic participant while the traffic participant is moving in the traffic participant priority section.

(6): In the aspect of (5) described above, the driving controller switches the risk area when the traffic participant is present in the traffic participant priority section and the traffic participant crosses a center of the traveling lane of the vehicle.

(7): A vehicle control method according to another aspect of the present invention includes, by a computer, recognizing a surrounding situation of a vehicle, executing driving control of controlling one or both of a speed and steering of the vehicle on the basis of the recognized surrounding situation, recognizing a traffic participant present in front of the vehicle and a traffic participant priority section present in a traveling direction of the vehicle from the surrounding situation of the vehicle, setting a risk area for the traffic participant priority section on the basis of a position and a traveling direction of the traffic participant, and executing the driving control based on the set risk area and the position of the traffic participant.

(8): A storage medium according to still another aspect of the present invention is a computer readable non-transitory storage medium that has stored a program causing a computer to execute recognizing a surrounding situation of a vehicle, executing a driving control of controlling one or both of a speed and steering of the vehicle on the basis of the recognized surrounding situation, recognizing a traffic participant present in front of the vehicle and a traffic participant priority section present in a traveling direction of the vehicle from a surrounding situation of the vehicle, setting a risk area for the traffic participant priority section on the basis of a position and a traveling direction of the traffic participant, and executing the driving control based on the set risk area and the position of the traffic participant.

According to the aspects of (1) to (8) described above, it is possible to execute driving control of a vehicle based on more appropriate recognition of traffic participants.

### BRIEF DESCRIPTION OF THE DRAWINGS

FIG. 1 is a configuration diagram of a vehicle system using a vehicle control device according to an embodiment.

FIG. 2 is a functional configuration diagram of a first controller and a second controller.

FIG. 3 is a diagram for describing recognition of traffic participants and priority sections, and setting of risk areas.

FIG. 4 is a diagram for describing a situation in which a pedestrian passes through a pedestrian crossing from an outside of a lane.

FIG. 5 is a diagram for describing a situation of pedestrians and vehicles at a time t2.

FIG. 6 is a diagram for describing the situation of pedestrians and vehicles at a time t3.

FIG. 7 is a diagram for describing the situation of pedestrians and vehicles at a time t4.

FIG. 8 is a diagram for describing a situation in which the pedestrian passes through the pedestrian crossing from the outside of the lane.

FIG. 9 is a diagram for describing the situation of pedestrians and vehicles at a time t6.

FIG. 10 is a diagram for describing the situation of pedestrians and vehicles at a time t7.

FIG. 11 is a diagram for describing the situation of pedestrians and vehicles at a time t8.

FIG. 12 is a diagram for describing first switching control of the risk area.

FIG. 13 is a diagram for describing third switching control of the risk area.

FIG. 14 is a flowchart which shows an example of a flow of driving control processing executed by an automated driving control device.

### DESCRIPTION OF EMBODIMENTS

Hereinafter, embodiments of a vehicle control device, a vehicle control method, and a storage medium of the present invention will be described with reference to the drawings. In the following description, as an example, embodiments in which the vehicle control device is applied to an automated driving vehicle will be described. Automated driving is, for example, automatically controlling one or both of steering and acceleration or deceleration of a vehicle to execute driving control. The vehicle driving control may include various driving assists such as a lane keeping assistance system (LKAS), adaptive cruise control (ACC), and auto lane changing (ALC). Automated driving vehicles may have some or all of their driving controlled by the manual driving of the occupant (driver). In the following description, a case in which the left-hand traffic rule is applied will be described, but when the right-hand traffic rule is applied, the left and right sides may be read in reverse.

[Overall Configuration]

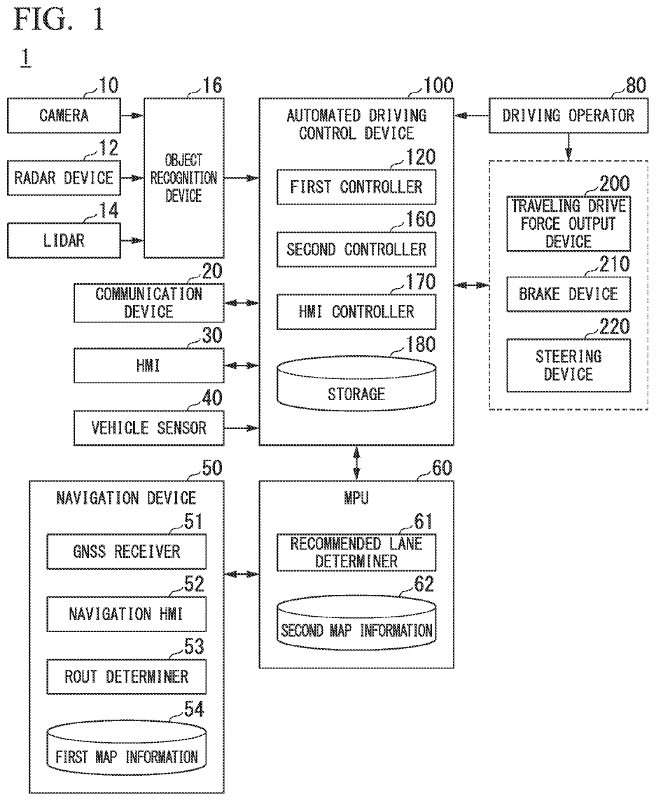

FIG. 1 is a configuration diagram of a vehicle system 1 using a vehicle control device according to an embodiment. A vehicle in which the vehicle system 1 is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination of these. The electric motor operates by using electric power generated by a generator connected to the internal combustion engine or discharge power of secondary batteries or fuel cells.

The vehicle system 1 includes, for example, a camera 10, a radar device 12, a light detection and ranging (LIDAR) 14, an object recognition device 16, a communication device 20, a human machine interface (HMI) 30, and a vehicle sensor 40, a navigation device 50, a map positioning unit (MPU) 60, a driving operator 80, an automated driving control device 100, a traveling drive force output device 200, a brake device 210, and a steering device 220. These devices and apparatuses are connected to each other by a multiplex communication line such as a controller area network (CAN) communication line, a serial communication line, a wireless communication network, or the like. The configuration shown in FIG. 1 is merely an example, and a part of the configuration may be omitted or another configuration may be added.

The camera 10 is a digital camera that uses a solid-state image sensor such as a charge coupled device (CCD) or a complementary metal oxide semiconductor (CMOS). The camera 10 is attached to an arbitrary place in a vehicle in which the vehicle system 1 is mounted (hereinafter, referred to as a vehicle M). When an image of the front is captured, the camera 10 is attached to an upper part of the front windshield, a back surface of the windshield rear-view mirror, and the like. When a rear of the vehicle M is captured, the camera 10 is attached to an upper part of the rear windshield, the back door, and the like. When sides and a rear side of the vehicle M are captured, the camera 10 is attached to a door mirror and the like. The camera 10 repeatedly captures, for example, an image of a periphery of the vehicle M periodically. The camera 10 may be a stereo camera.

The radar device 12 radiates radio waves such as millimeter waves to the vicinity of the vehicle M, and detects radio waves (reflected waves) reflected by an object to detect at least the position (distance and orientation) of the object. The radar device 12 is attached to an arbitrary place of the vehicle M. The radar device 12 may detect the position and speed of the object by a frequency modulated continuous wave (FM-CW) method.

The LIDAR14 irradiates the vicinity of the vehicle M with light (or an electromagnetic wave having a wavelength close to that of light) and measures scattered light. The LIDAR 14 detects a distance to a target on the basis of a time from light emission to light reception. The emitted light is, for example, a pulsed laser beam. The LIDAR 14 is attached to arbitrary place of the vehicle M.

The object recognition device 16 performs sensor fusion processing on results of detection by some or all of the camera 10, the radar device 12, and the LIDAR 14, and recognizes the position, type, speed, and the like of the object. The object recognition device 16 outputs a result of the recognition to the automated driving control device 100. The object recognition device 16 may output the results of the detection by the camera 10, the radar device 12, and the LIDAR 14 to the automated driving control device 100 as they are. In this case, the object recognition device 16 may be omitted from the vehicle system 1.

The communication device 20 communicates with other vehicles existing in the vicinity of the vehicle M by using, for example, a cellular network, a Wi-Fi network, Bluetooth (registered trademark), dedicated short range communication (DSRC) and the like, or communicates with various server devices via a wireless base station.

The HMI 30 presents various types of information to the occupant of the vehicle M and receives an input operation from the occupant. The HMI 30 includes various display devices, speakers, microphones, buzzers, touch panels, switches, keys and the like.

The vehicle sensor 40 includes a vehicle speed sensor that detects a speed of the vehicle M, an acceleration sensor that detects the acceleration, a yaw rate sensor that detects the angular speed around the vertical axis, an azimuth sensor that detects a direction of the vehicle M, and the like. The vehicle sensor 40 may include a position sensor that acquires a position of the vehicle M. The position sensor is, for example, a sensor that acquires position information (longitude/latitude information) from a global positioning system (GPS) device. The position sensor may be a sensor that acquires position information using the global navigation satellite system (GNSS) receiver 51 of the navigation device 50.

The navigation device 50 includes, for example, a GNSS receiver 51, a navigation HMI 52, and a route determiner 53. The navigation device 50 holds first map information 54 in a storage device such as a hard disk drive (HDD) or a flash memory. The GNSS receiver 51 identifies the position of the vehicle M on the basis of a signal received from a GNSS satellite. The position of the vehicle M may be identified or complemented by an inertial navigation system (INS) using an output of the vehicle sensor 40. The navigation HMI 52 includes a display device, a speaker, a touch panel, a key, and the like. The navigation HMI 52 may be partially or entirely shared with the HMI 30 described above. The route determiner 53 determines, for example, a route from the position of the vehicle M (or an arbitrary position to be input) identified by the GNSS receiver 51 to a destination to be input by the occupant using the navigation HMI 52 (hereinafter, a route on a map) with reference to the first map information 54. The first map information 54 is, for example, information in which a road shape is expressed by a link indicating a road and nodes connected by a link. The first map information 54 may include a road curvature, point of interest (POI) information, and the like. A route on a map is output to the MPU 60. The navigation device 50 may perform route guidance using the navigation HMI 52 on the basis of the route on a map. The navigation device 50 may be realized by, for example, a function of a terminal device such as a smartphone or a tablet terminal owned by the occupant. The navigation device 50 may transmit a current position and a destination to a navigation server via the communication device 20 and acquire a route equivalent to the route on a map from the navigation server.

The MPU 60 includes, for example, a recommended lane determiner 61, and holds second map information 62 in a storage device such as an HDD or a flash memory. The recommended lane determiner 61 divides the route on a map provided from the navigation device 50 into a plurality of blocks (for example, divides every 100 [m] in a vehicle traveling direction), and determines a recommended lane for each block with reference to the second map information 62. The recommended lane determiner 61 determines which numbered lane from the left to drive. When a branch place is present on the route on a map, the recommended lane determiner 61 determines a recommended lane so that the vehicle M can travel on a reasonable route to proceed to the branch destination.

The second map information 62 is map information with higher accuracy than the first map information 54. The second map information 62 includes, for example, information on a center of a lane, information on a boundary of the lane, and the like. The second map information 62 may include road information, traffic regulation information, address information (addresses/zip codes), facility information, telephone number information, and the like. The second map information 62 may be updated at any time by the communication device 20 communicating with another device.

The driving operator 80 includes, for example, an accelerator pedal, a brake pedal, a shift lever, a steering wheel, an odd-shaped steering wheel, a joystick, and other operators. The driving operator 80 has a sensor that detects the amount of operation or a presence or absence of an operation attached thereto, and a result of detection is output to the automated driving control device 100, or some or all of the traveling drive force output device 200, the brake device 210, and the steering device 220.

The automated driving control device 100 includes, for example, a first controller 120, a second controller 160, an HMI controller 170, and a storage 180. The first controller 120, the second controller 160, and the HMI controller 170 are realized by, for example, a hardware processor such as a central processing unit (CPU) executing a program (software), respectively. Some or all of these components may be realized by hardware (a circuit unit; including circuitry) such as large scale integration (LSI), an application specific integrated circuit (ASIC), a field-programmable gate array (FPGA), or a graphics processing unit (GPU), or may be realized by software and hardware in cooperation. A program may be stored in advance in a storage device (a storage device having a non-transitory storage medium) such as an HDD or flash memory of the automated driving control device 100, or may be stored in a detachable storage medium such as a DVD or a CD-ROM and installed in the HDD or flash memory of the automated driving control device 100 by the storage medium (non-transitory storage medium) being attached to a drive device. The automated driving control device 100 is an example of a “vehicle control device.” A combination of the action plan generator 140 and the second controller 160 is an example of a “driving controller.”

The storage 180 may be realized by various storage devices described above, a solid-state drive (SSD), an electrically erasable programmable read only memory (EEPROM), a read only memory (ROM), a random access memory (RAM), or the like. The storage 180 stores, for example, information necessary for executing the driving control in the present embodiment, a program, various other information, and the like. The first map information 54 and the second map information 62 may be stored in the storage 180.

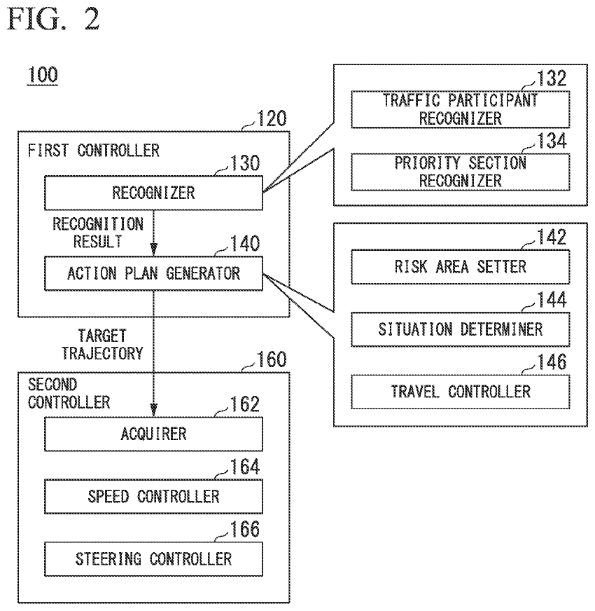

FIG. 2 is a functional configuration diagram of the first controller 120 and the second controller 160. The first controller 120 includes, for example, a recognizer 130 and an action plan generator 140. The first controller 120 realizes, for example, a function by artificial intelligence (AI) and a function of a predetermined model in parallel. For example, a function of “recognizing an intersection” may be realized by executing both recognition of an intersection by deep learning and recognition based on a predetermined condition (a signal for pattern matching, a road sign, or the like) in parallel, and scoring and comprehensively evaluating the both. As a result, reliability of automated driving is ensured.

The recognizer 130 recognizes states such as a position, a speed, and an acceleration of an object in the vicinity of the vehicle (for example, within a predetermined distance from the vehicle M) on the basis of the information input from the camera 10, the radar device 12, and the LIDAR 14 via the object recognition device 16. Objects include other vehicles, traffic participants passing through roads, road structures, other objects present in the vicinity, and the like. Traffic participants include, for example, pedestrians, means of transportation such as bicycles and wheelchairs (or people who ride them), and the like. Road structures include, for example, road signs, traffic lights, railroad crossings, curbs, medians, guardrails, fences, and the like. The road structures may include, for example, road marking lines drawn or pasted on road surfaces, or road markings such as pedestrian crossings, bicycle crossings, and stop lines. The position of an object is recognized as, for example, a position on absolute coordinates with a representative point (a center of gravity, a center of drive axis, or the like) of the vehicle M set as the origin, and is used for control. The position of an object may be represented by a representative point such as the center of gravity or the corner of the object, or may be represented by an expressed area. When the object is another vehicle, the “state” of the object may include the acceleration or jerk of the object, or a “behavioral state” (for example, whether the vehicle is changing the lane or is about to change the lane).

The recognizer 130 recognizes, for example, a lane (a traveling lane) in which the vehicle M is traveling. For example, the recognizer 130 compares a pattern of road marking lines obtained from the second map information 62 (for example, an arrangement of solid lines and broken lines) and a pattern of road marking lines in the vicinity of the vehicle M recognized from an image captured by the camera 10 to recognize the traveling lane. The recognizer 130 may also recognize the traveling lane by recognizing a traveling road boundary (road boundary) of a road structure or the like, not limited to road marking lines. In this recognition, the position of the vehicle M acquired from the navigation device 50 and a result of processing by INS may be taken into account.

The recognizer 130 recognizes the position and posture of the vehicle M with respect to the traveling lane when the traveling lane is recognized. The recognizer 130 may recognize, for example, a deviation of a reference point of the vehicle M from the center of the lane and an angle of the vehicle M formed against a line connecting the center of the lane in a traveling direction of the vehicle M as relative position and posture of the vehicle M with respect to the traveling lane. Instead, the recognizer 130 may recognize the position of the reference point of the vehicle M with respect to any side end (road marking lines or road boundaries) of the traveling lane as the relative position of the vehicle M with respect to the traveling lane. The recognizer 130 recognizes stop lines, obstacles, traffic lights, tollhouses, and other road events.

The recognizer 130 includes, for example, a traffic participant recognizer 132 and a priority section recognizer 134. Details of functions of the traffic participant recognizer 132 and the priority section recognizer 134 will be described below.

In principle, the action plan generator 140 travels in a recommended lane determined by the recommended lane determiner 61, and, furthermore, generates a target trajectory on which the vehicle M will automatically travel (regardless of an operation of a driver) in the future to be able to respond to surrounding conditions of the vehicle M. The target trajectory includes, for example, a speed element. For example, the target trajectory is expressed as a sequence of points (trajectory points) to be reached by the vehicle M. The trajectory point is a point to be reached by the vehicle M for each predetermined traveling distance (for example, about several [m]) along a road, and, separately, a target speed and a target acceleration for each predetermined sampling time (for example, about decimal point number [sec]) are generated as a part of the target trajectory. The trajectory point may be a position to be reached by the vehicle M at a predetermined sampling time for each corresponding sampling time. In this case, information on the target speed and target acceleration is expressed by an interval between trajectory points.

The action plan generator 140 may set an event of automated driving when a target trajectory is generated. The event of automated driving includes a constant-speed traveling event, a low-speed following traveling event, a lane change event, a branching event, a merging event, a takeover event, and an emergency stop event. The action plan generator 140 generates a target trajectory according to an event to be started.

The action plan generator 140 includes, for example, a risk area setter 142, a situation determiner 144, and a travel controller 146. Details of functions of the risk area setter 142, the situation determiner 144, and the travel controller 146 will be described below.

The second controller 160 controls the traveling drive force output device 200, the brake device 210, and the steering device 220 such that the vehicle M passes through a target trajectory generated by the action plan generator 140 at a scheduled time.

The second controller 160 includes, for example, an acquirer 162, a speed controller 164, and a steering controller 166. The acquirer 162 acquires information on a target trajectory (trajectory points) generated by the action plan generator 140 and stores it in a memory (not shown). The speed controller 164 controls the traveling drive force output device 200 or the brake device 210 based on a speed element associated with the target trajectory stored in the memory. The steering controller 166 controls the steering device 220 according to a degree of bending of the target trajectory stored in the memory. Processing of the speed controller 164 and the steering controller 166 is realized by, for example, a combination of feedforward control and feedback control. As an example, the steering controller 166 executes the combination of feedforward control according to a curvature of a road in front of the vehicle M and feedback control based on a deviation from the target trajectory in combination.

The HMI controller 170 notifies the occupant of predetermined information using the HMI 30. The predetermined information includes information related to the traveling of the vehicle M, such as information on the state of the vehicle M and information on driving control. The information on the state of the vehicle M includes, for example, the speed of the vehicle M, an engine speed, a shift position, and the like.

The information on driving control includes, for example, an inquiry as to whether to change the lane, information imposed on the occupant, which is required to switch from automated driving to manual driving (task request information for the occupant), and information on the status of driving control (for example, content of a running event), and the like. The predetermined information may include information not related to travel control of the vehicle M, such as content (for example, a movie) stored in a storage medium such as a television program or a DVD.

For example, the HMI controller 170 may generate an image including the predetermined information described above and display the generated image on a display device of the HMI 30, or may generate a sound indicating the predetermined information and cause the generated sound to be output from a speaker of the HMI 30. The HMI controller 170 may also output information received by the HMI 30 to the communication device 20, the navigation device 50, the first controller 120, and the like.

The traveling drive force output device 200 outputs a traveling drive force (torque) for the vehicle to travel to the drive wheels. The traveling drive force output device 200 includes, for example, a combination of an internal combustion engine, a motor, a transmission, and the like, and an electronic control unit (ECU) that controls these. The ECU controls the configuration described above according to information input from the second controller 160 or information input from the driving operator 80.

The brake device 210 includes, for example, a brake caliper, a cylinder that transmits a hydraulic pressure to the brake caliper, an electric motor that generates a hydraulic pressure in the cylinder, and a brake ECU. The brake ECU controls the electric motor according to the information input from the second controller 160 or the information input from the driving operator 80 so that a brake torque according to a braking operation is output to each wheel. The brake device 210 may include a mechanism for transmitting a hydraulic pressure generated by an operation of a brake pedal included in the driving operator 80 to the cylinder via a master cylinder as a backup. The brake device 210 is not limited to the configuration described above, and may be an electronically controlled hydraulic brake device that controls an actuator according to the information input from the second controller 160 to transmit the hydraulic pressure of the master cylinder to the cylinder.

The steering device 220 includes, for example, a steering ECU and an electric motor. The electric motor changes, for example, a direction of a steering wheel by applying a force to a rack and pinion mechanism. The steering ECU drives the electric motor according to the information input from the second controller 160 or the information input from the driving operator 80, and changes the direction of the steering wheel.

[Traffic Participant Recognizer 132, Priority Section Recognizer 134, and Risk Area Setter 142]

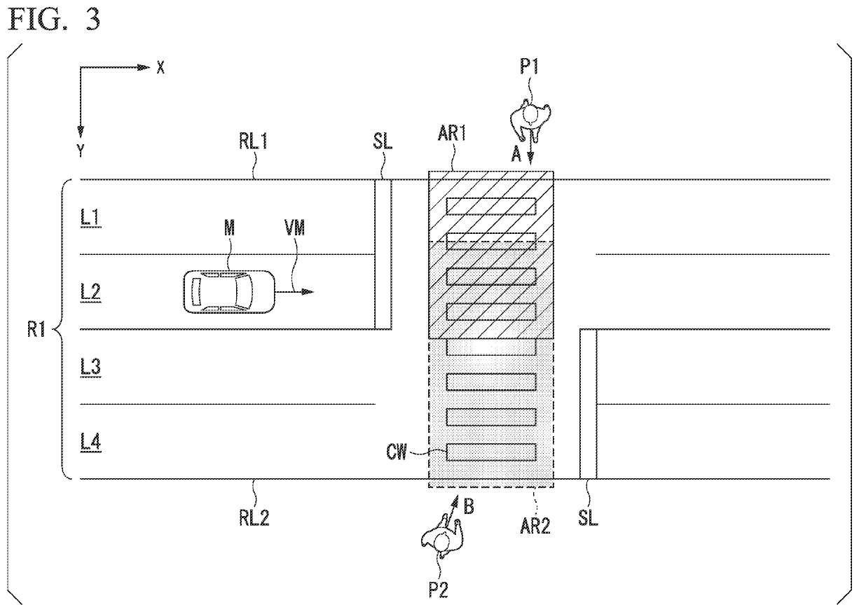

Next, details of functions of the traffic participant recognizer 132, the priority section recognizer 134, and the risk area setter 142 will be described. FIG. 3 is a diagram for describing recognition of a traffic participant and a priority section, and setting of a risk area. In the example of FIG. 3, a road R1 which has two lanes for travel in the same direction is shown. In the example of FIG. 3, in lanes L1 and L2, travel is possible in an X-axis direction, and in lanes L3 and L4, travel is possible in a −X-axis direction. That is, the lanes L3 and L4 are opposite lanes of the lanes L1 and L2. A Y-axis direction indicates a lateral direction of the road R1, and a lateral position indicates a position in the lateral direction. In the example of FIG. 3, the vehicle M is traveling in the lane L2 at a speed VM. In the example of FIG. 3, each of the lanes L1 to L4 is provided with a temporary stop line SL for vehicles to stop in front of the pedestrian crossing CW. In the following description, a situation where the pedestrian crossing CW is not provided with a traffic light will be described, but when the traffic light is provided, travel control such as stopping the vehicle M and passing the pedestrian crossing CW is executed according to an instruction of the traffic light. Before reaching the pedestrian crossing CW, the vehicle M is assumed to have received driving control of driving one or both of the steering and speed by the driving controller.

The traffic participant recognizer 132 recognizes a traffic participant who is in front of the vehicle M and within a first predetermined distance from the vehicle M on the basis of the information input from the camera 10, the radar device 12, and the LIDAR 14 via the object recognition device 16. The first predetermined distance may be, for example, a fixed distance, or may be a variable distance according to the speed of the vehicle M, the road shape, and the number of lanes of the road. For example, the traffic participant recognizer 132 analyzes an image captured by the camera 10 using image processing (edge detection, binarization processing, feature amount extraction, image enhancement processing, image extraction, pattern matching processing, or the like), and detects a three-dimensional position, size, shape, and the like of the traffic participant contained in the captured image by a well-known method on the basis of a result of the analysis. For example, the traffic participant recognizer 132 stores a pattern matching model for identifying a traffic participant in the storage 180 or the like in advance, and identifies the traffic participant contained in the image with reference to the model on the basis of the result of the analysis of the image captured by the camera 10.

The traffic participant recognizer 132 recognizes a position and a traveling direction (moving direction) of the recognized traffic participant. The traffic participant recognizer 132 may recognize a speed of the traffic participant. The traffic participant recognizer 132 may recognize a type of the traffic participant (for example, a pedestrian, a bicycle, a wheelchair). When the type of the traffic participant is a pedestrian, the traffic participant recognizer 132 may recognize a type of the pedestrian, such as whether the pedestrian is a child or an elderly person, based on characteristic information such as a height and a posture of the pedestrian.

The traffic participant recognizer 132 may recognize, for example, a traffic participant who passes through a section (traffic participant priority section) in which traffic of a traffic participant is prioritized over the vehicle M, recognized by the priority section recognizer 134, or a traffic participant who is predicted to pass through a traffic participant priority section in the near future. In the example of FIG. 3, the traffic participant recognizer 132 recognizes positions and traveling directions (moving directions) A and B of pedestrians P1 and P2.

The priority section recognizer 134 recognizes a traffic participant priority section (hereinafter referred to as “priority section”) present within the second predetermined distance from the vehicle M in the traveling direction of the vehicle M (on a road on which the vehicle M travels). The second predetermined distance may be a fixed distance, or may be a variable distance according to the speed of the vehicle M, the road shape, and the number of lanes of the road. The second predetermined distance may be the same distance as the first predetermined distance or may be a different distance. The priority section is, for example, a pedestrian crossing or bicycle crossing zone. The priority section may include, for example, an area at or near an intersection that is not provided with a pedestrian crossing (an area where a traffic participant is highly predicted to cross the road R1). The priority section may be a section preset by an administrator or the like. For example, the priority section recognizer 134 analyzes the image captured by the camera 10 using image processing or the like, and recognizes a priority section present within the second predetermined distance in the traveling direction of the vehicle M on the basis of a result of the analysis. The priority section recognizer 134 may refer to map information (the first map information 54, the second map information 62) on the basis of positional information of the vehicle obtained from the vehicle sensor 40, and recognize a priority section present within the second predetermined distance in the traveling direction of the vehicle M. The priority section recognizer 134 may recognize a final priority section by collating the priority section recognized from the image taken by the camera 10 with the priority section recognized from the map information. In the example of FIG. 3, the priority section recognizer 134 recognizes the pedestrian crossing CW.

The risk area setter 142 sets a risk area for the pedestrian crossing CW when a traffic participant is recognized by the traffic participant recognizer 132 and the traffic participant is present in the pedestrian crossing CW recognized by the priority section recognizer 134 or is predicted to enter the pedestrian crossing CW in the near future on the basis of the position and traveling direction of the recognized traffic participant. The risk area is an area where it is predicted that the vehicle M and the traffic participant may come into contact with each other (risk) when the traffic participant is present in the area.

For example, the risk area setter 142 sets different risk areas depending on when a traffic participant on an outside of the road R1 (an outside of a road partitioned by road marking lines RL1 and RL2) enters the pedestrian crossing CW from a side end on the side of the lane L1 in which travel in the same direction as the traveling direction of the vehicle M is possible (a road marking line RL1 in FIG. 3) and when the traffic participant enters the pedestrian crossing CW from a side end on the opposite lane L4 side of the lane in which travel in the same direction as the host vehicle M is possible (a road marking line RL2 in FIG. 3). For example, when the traffic participant enters the pedestrian crossing CW, the risk area setter 142 sets an area including an area from an end of the pedestrian crossing CW on an entering side to a position beyond the lane L2 (hereinafter referred to as a traveling lane L2) in which the vehicle M travels as a risk area.

In the example of FIG. 3, the risk area setter 142 predicts that the pedestrians P1 and P2 will cross the road R1 through the pedestrian crossing CW in the near future on the basis of the positions and the traveling directions A and B of the pedestrians P1 and P2 because the pedestrians P1 and P2 are heading toward the pedestrian crossing CW. Then, the risk area setter 142 sets a risk area for each of the pedestrians P1 and P2. For the pedestrian P1, the risk area setter 142 sets a first risk area AR1 that includes an entire pedestrian crossing CW in the X-axis direction and includes the end of the pedestrian crossing CW on the entering side (for example, the road marking line RL1) to the position beyond the entire traveling lane L2 (the entire lateral direction) in the Y-axis direction. For the pedestrian P2, the risk area setter 142 sets a second risk area AR2 that includes the entire pedestrian crossing CW in the X-axis direction and includes the end of the pedestrian crossing CW on the entering side (for example, the road marking line RL2) to the position beyond the entire traveling lane L2 (the entire lateral direction) in the Y-axis direction. The first risk area AR1 and the second risk area AR2 may overlap in some areas as shown in FIG. 3. Some areas may include, for example, at least an area on the pedestrian crossing CW where the vehicle M is predicted to pass through, or an area associated with a lane width of the traveling lane L2. The risk area setter 142 may adjust the first risk area AR1 and the second risk area AR2 according to the type and speed of the traffic participant, and the position, speed VM, and the like of the vehicle M.

[Situation Determiner 144 and Travel Controller 146]

Next, details of functions of the situation determiner 144 and the travel controller 146 will be described. The situation determiner 144 determines a passage status of the pedestrian crossing by a traffic participant on the basis of the position and the traveling direction of the traffic participant recognized by the traffic participant recognizer 132. For example, the situation determiner 144 may determine whether the traffic participant is present in a risk area, or may determine whether the vehicle M and the traffic participant come into contact with each other. The travel controller 146 generates a target trajectory of the vehicle M on the basis of a result of the determination by the situation determiner 144, outputs the generated target trajectory to the second controller 160, and executes driving control (speed control or steering control). Hereinafter, situation determination when each of the pedestrians P1 and P2, who are examples of the traffic participant, uses the pedestrian crossing CW and travel control of the vehicle M will be described.

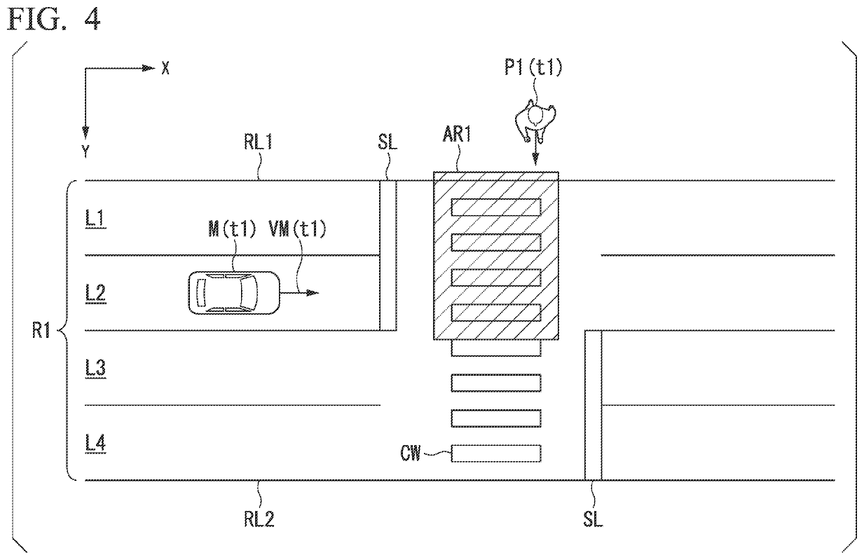

FIG. 4 is a diagram for describing a situation where the pedestrian P1 passes through the pedestrian crossing CW from the outside of the lane L1. In the following description, at a time t*, the position and speed of the vehicle are expressed as M(t*) and VM(t*), and the positions of the pedestrian P1 and P2 are expressed as P1(t*) and P2(t*). The situation determiner 144 determines whether the pedestrian P1 is present in the first risk area AR1 on the basis of the position of the pedestrian P1. At a time t1, it is determined that the vehicle M is unlikely to come into contact with the pedestrian P1 because the pedestrian P1 is not present in the first risk area AR1. Since it is determined by the situation determiner 144 that the vehicle M and the pedestrian P1 will not come into contact with each other even if the vehicle M and the pedestrian P1 pass as they are, the travel controller 146 causes the vehicle M to pass through the pedestrian crossing CW while maintaining the current speed VM without executing driving control of causing it to decelerate, stop, or avoid contact with the pedestrian P1.

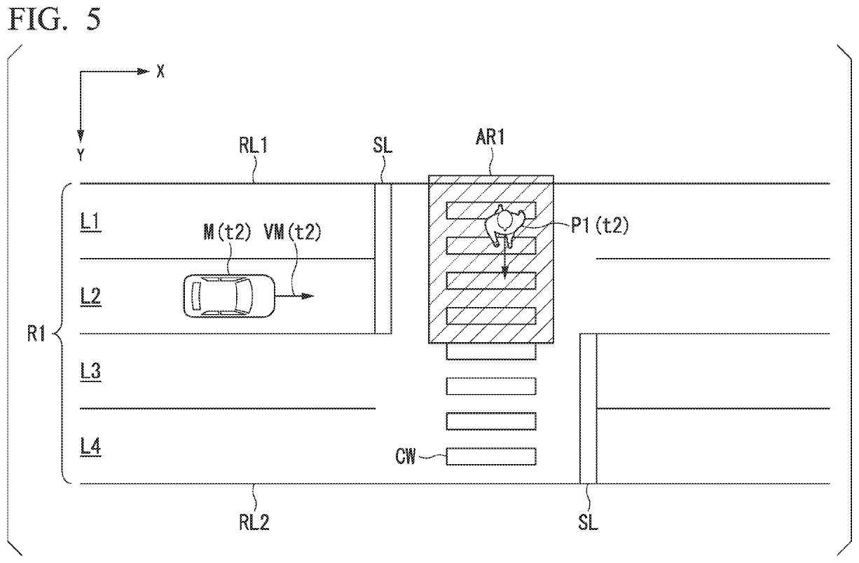

FIG. 5 is a diagram for describing the situation of the pedestrian P1 and the vehicle M at a time t2. At the time t2, the situation determiner 144 determines that the pedestrian P1 is within the first risk area AR1 on the basis of the position of the pedestrian P1. The situation determiner 144 determines that the vehicle M may come into contact with the pedestrian P1 because the pedestrian P1 is not present in the area where the vehicle M passes through the pedestrian crossing CW but is present in the first risk area AR1. In this case, the travel controller 146 performs control of causing the vehicle M to decelerate or stop before the temporary stop line SL. Furthermore, the travel controller 146 may perform steering control of avoiding contact with the pedestrian P1 in addition to (or instead of) speed control. The situation determiner 144 may set different flags depending on when the pedestrian P1 is and is not present in the first risk area AR1. In this case, the travel controller 146 refers to the flag set by the situation determiner 144, determines whether the pedestrian P1 is present in the first risk area AR1, and performs travel control corresponding to the flag.

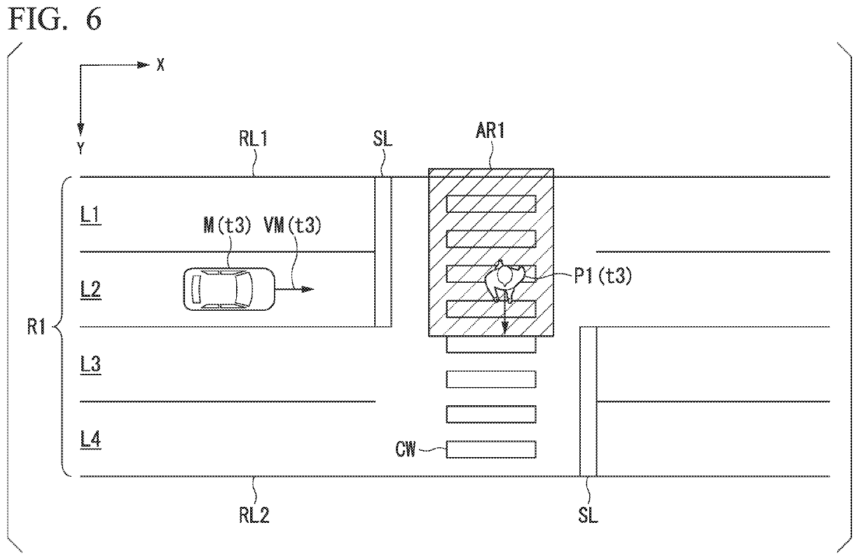

FIG. 6 is a diagram for describing the situation of the pedestrian P1 and the vehicle M at a time t3. At the time t3, the situation determiner 144 determines that the pedestrian P1 is present in the first risk area AR1. The situation determiner 144 may determine that the vehicle M and the pedestrian P1 may come into contact with each other. In this case, the travel controller 146 performs control of causing the vehicle M to decelerate, to stop before the temporary stop line SL, or to avoid contact. At the time t3, since the pedestrian P1 is present on a trajectory on which the vehicle M travels (a lateral position corresponding to the lane width of the lane L2), the vehicle M and the pedestrian P1 are highly likely to come into contact compared with the situation at the time t2. For this reason, the travel controller 146 may perform stop or avoidance control instead of traveling slowly after decelerating or the like.

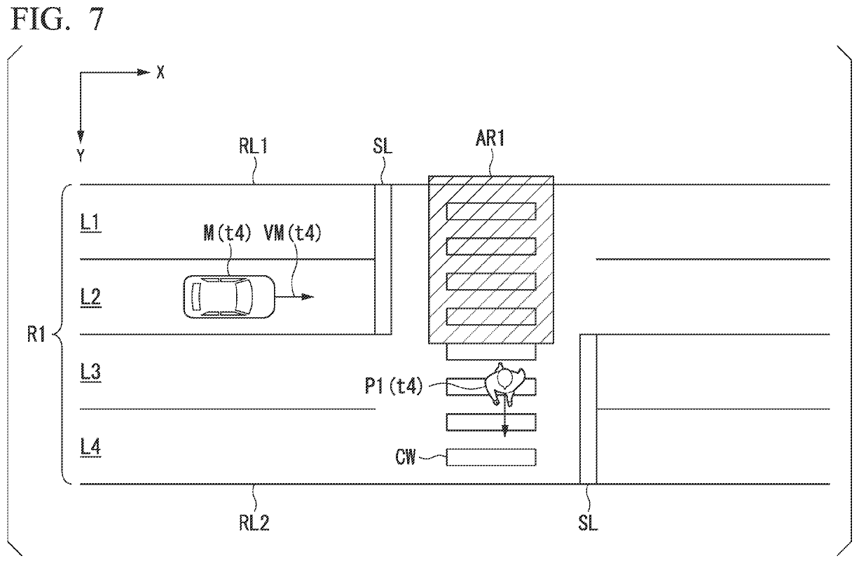

FIG. 7 is a diagram for describing the situation of the pedestrian P1 and the vehicle M at a time t4. At the time t4, the situation determiner 144 determines that the pedestrian P1 is not present in the first risk area AR1. Even if the pedestrian P1 is crossing the pedestrian crossing CW, it may be determined that the vehicle M is unlikely to come into contact with the pedestrian P1. In this case, the travel controller 146 causes the vehicle M to pass through the pedestrian crossing CW while maintaining the speed VM (t4). If the vehicle M is stopped before the temporary stop line at the time t4, the travel controller 146 performs control of starting to travel and causes the vehicle M to pass through the pedestrian crossing CW.

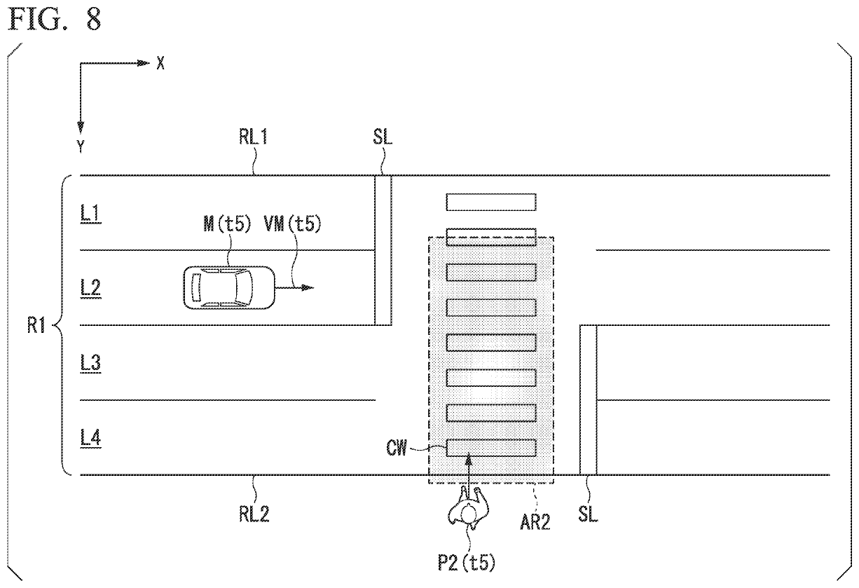

FIG. 8 is a diagram for describing a situation where the pedestrian P2 passes through the pedestrian crossing CW from outside of the lane L4. The situation determiner 144 determines whether the pedestrian P2 is present in the second risk area AR2 on the basis of the position of the pedestrian P2. At a time t5, it is determined that the vehicle M is unlikely to come into contact with the pedestrian P2 because the pedestrian P2 is not present in the second risk area AR2. Since it is determined by the situation determiner 144 that the pedestrian P2 and the vehicle M will not come into contact with each other even if the vehicle M and the pedestrian P2 pass as they are, the travel controller 146 causes the vehicle M to pass through the pedestrian crossing CW while maintaining the current speed VM without executing driving control of causing it to decelerate, stop, or avoid contact with the pedestrian P2.

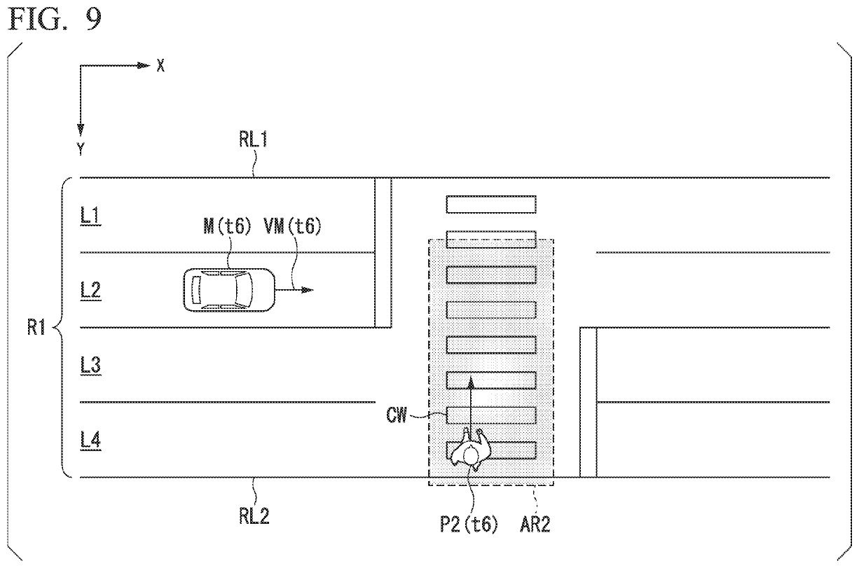

FIG. 9 is a diagram for describing the situation of the pedestrian P2 and the vehicle M at a time t6. At the time t6, the situation determiner 144 determines that the pedestrian P2 is present in the second risk area AR2 on the basis of the position of the pedestrian P2. The situation determiner 144 determines that the vehicle M may come into contact with the pedestrian P2 because the pedestrian P2 is not present in an area where the vehicle M passes through the pedestrian crossing CW but is present in the second risk area AR2. In this case, the travel controller 146 performs control of causing the vehicle M to decelerate or stop before the temporary stop line SL. Moreover, the travel controller 146 may perform, in addition to (or instead of) speed control, steering control to avoid contact with the pedestrian P2. The situation determiner 144 may set different flags depending on when the pedestrian P2 is and is not present in the second risk area AR2. In this case, the travel controller 146 refers to a flag set by the situation determiner 144, determines whether the pedestrian P2 is present in the second risk area AR2, and performs travel control corresponding to the flag.

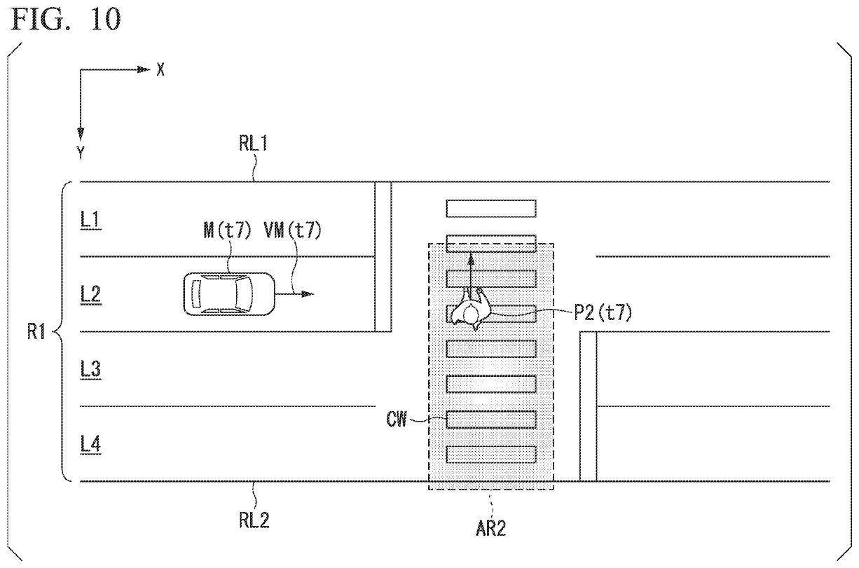

FIG. 10 is a diagram for describing the situation of the pedestrian P1 and the vehicle M at a time t7. At the time t7, the situation determiner 144 determines that the pedestrian P2 is present in the second risk area AR2. The situation determiner 144 may determine that the vehicle M and the pedestrian P2 may come into contact with each other. In this case, the travel controller 146 controls the vehicle M to decelerate, stop before the temporary stop line SL, and avoid the contact. At the time t7, since the pedestrian P2 is present on a trajectory on which the vehicle M travels (a lateral position corresponding to the lane width of the lane L2), the vehicle M and the pedestrian P2 are highly likely to come into contact compared with the situation at the time t6. For this reason, the travel controller 146 may perform stop or avoidance control instead of traveling slowly after decelerating.

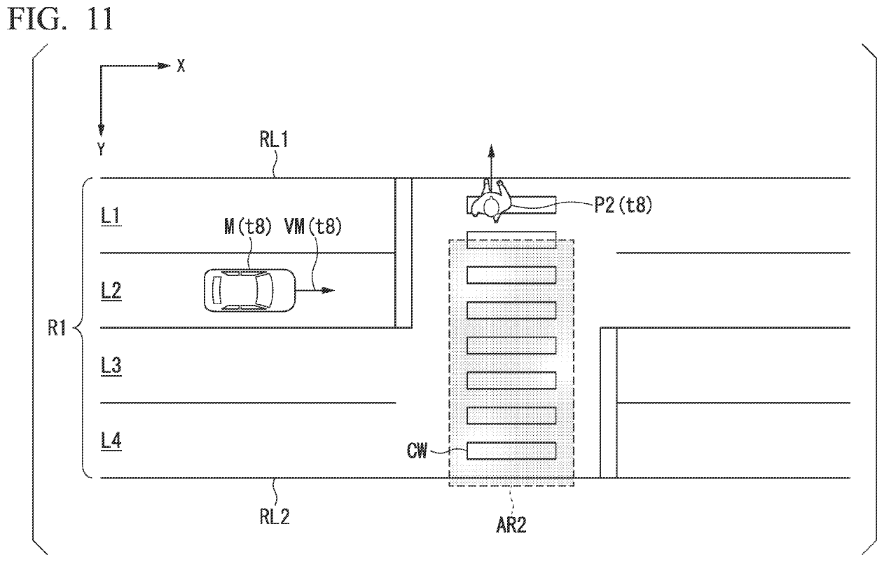

FIG. 11 is a diagram for describing the situation of the pedestrian P2 and the vehicle M at a time t8. At the time t8, the situation determiner 144 determines that the pedestrian P2 is not present in the second risk area AR2. The situation determiner 144 may determine that the vehicle M is unlikely to come into contact with the pedestrian P2 even while the pedestrian P2 is crossing the pedestrian crossing CW. In this case, the travel controller 146 causes the vehicle M to pass through the pedestrian crossing CW while maintaining the speed VM (t8). Moreover, when the vehicle M is stopped before the stop line at the time t8, the travel controller 146 performs control of starting to travel and causes the vehicle M to pass through the pedestrian crossing CW.

As described above, a risk area is set for each of the pedestrians P1 and P2, and driving control is performed depending on whether a pedestrian is present in each set risk area, and thereby it is not necessary to simply continue stop control or the like until a pedestrian finishes passing through the pedestrian crossing CW, and excessive deceleration, stop, or avoidance control can be suppressed. Therefore, it is possible to execute vehicle driving control based on more appropriate recognition of a pedestrian. After a risk area is set, the driving control can be switched depending on whether a pedestrian is present in the risk area, and thus it is possible to execute high-speed determination processing and the driving control by simplifying the processing and to reduce a processing load of the system.

### MODIFIED EXAMPLE

The risk area setter 142 may switch the risk area according to the position of the traffic participant, the position of the vehicle M, or the like while the traffic participant is moving (crossing) the pedestrian crossing CW. In the following description, switching control of a risk area according to the embodiment will be described in several parts.

<First Switching Control>

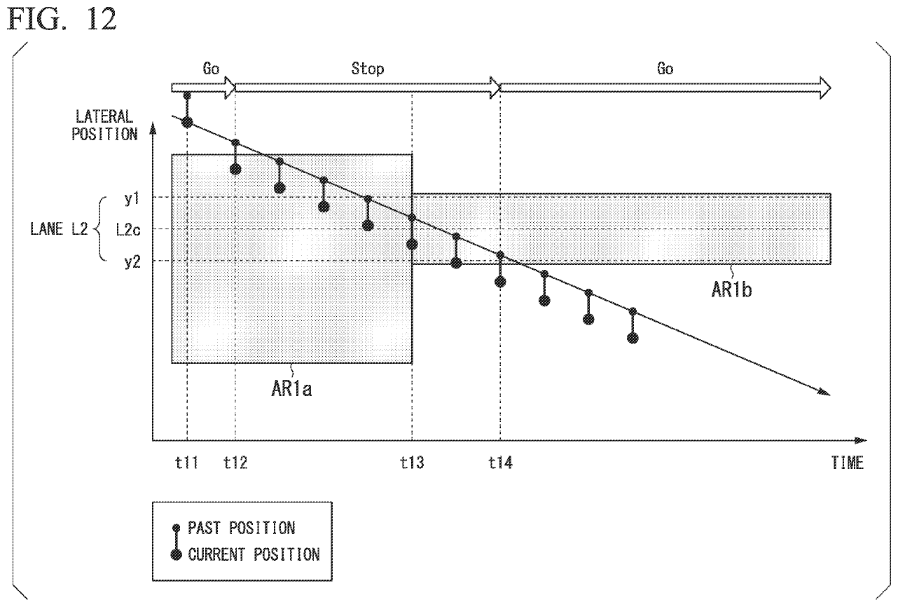

FIG. 12 is a diagram for describing first switching control of a risk area. In the example of FIG. 12, the horizontal axis indicates time, and the vertical axis indicates a lateral position (Y-axis position) of a road. A section from y1 to y2 of the lateral position of the road indicates the lane width of the lane L2 on which the vehicle M travels. In the example of FIG. 12, a relationship between a past position of a pedestrian (the position of the pedestrian before a predetermined time from the present) and a current position at a certain time t is shown. The past position and the current position are positions in the lateral direction of the road RE That is, in the example of FIG. 12, it is shown to which position the pedestrian is moving (crossing the road) from the past position at a certain time t. In the example of FIG. 12, it is assumed that time elapses in order of times t11, t12, t13, and t14. In the example of FIG. 12, it is shown that the pedestrian crosses the pedestrian crossing CW from a left side (the outside of lane L1) with respect to the traveling direction of the vehicle M, but the same method as a method to be described below can be applied to a case in which the pedestrian crosses the pedestrian crossing CW from a right side (the outside of the opposing lane L4) with respect to the traveling direction of the vehicle M.

For example, the risk area setter 142 sets the first risk area AR1 for the pedestrian crossing CW when the pedestrian crossing CW is recognized by the priority section recognizer 134 and the pedestrian is recognized by the traffic participant recognizer 132. In the example of FIG. 12, a first risk area AR1a is set first. Next, the risk area setter 142 determines whether the pedestrian is present in the first risk area AR1a and crosses a center L2c of the traveling lane L2 of the vehicle M. Crossing the center L2c of the traveling lane L2 means, for example, that the pedestrian crosses the center L2c of the traveling lane L2 or strides across the center L2c. The determination described above is determined by, for example, whether a straight line connecting the past position and the current position intersects a straight line indicating the center L2c, as shown in FIG. 12. The determination described above may be performed by the situation determiner 144. When it is determined that the pedestrian is present in the first risk area AR1a and has crossed the center L2c of the traveling lane L2 of the vehicle M, the risk area setter 142 performs control of switching the first risk area AR1a.

In the example of FIG. 12, the travel controller 146 causes the vehicle M to pass through the pedestrian crossing without performing control for deceleration, stop, avoidance, or the like because the pedestrian is not present in the first risk area AR1a at a time t11 (“Go” shown in FIG. 12), and performs the control such as deceleration, stop, avoidance, or the like (“Stop” shown in FIG. 12) at a time t12 because the pedestrian is present in the first risk area AR1a.

When it is determined that the pedestrian is present in the first risk area AR1a and the pedestrian has crossed the center L2c of the lane L2 at a time t13, the risk area setter 142 makes the first risk area AR1a smaller and switches to a first risk area AR1b whose width matches the width of the lane L2. As a result, for example, since the pedestrian is not present in the first risk area AR1b at a time t14, the driving control that allows the vehicle M to pass through the pedestrian crossing CW can be executed.

In the first switching control, the traffic participant recognizer 132 determines whether the pedestrian is moving in a direction away from the center L2c of the traveling lane L2 of the vehicle M, and, when it is determined that the pedestrian moves in the direction away from the center L2c, the risk area setter 142 may perform control of switching from the first risk area AR1a to the first risk area AR1b. The risk area setter 142 stores a movement area of the pedestrian, formed of a pair of a past position and a current position, and determines whether a specific pedestrian is crossing (whether it can be correctly recognized) on the basis of the stored information.

According to the first switching control described above, a risk area is adjusted (made smaller or narrower) depending on whether the pedestrian has crossed the center of the traveling lane of the vehicle M, and thereby it is possible to change to more appropriate risk area according to the situation of the pedestrian. Therefore, more appropriate driving control can be executed without performing control such as excessive deceleration, stop, or avoidance.

<Second Switching Control>

Second switching control is different from the first switching control in that it performs control of switching a risk area depending on whether a pedestrian has crossed a middle point (a center in a width direction of the road) of the pedestrian crossing CW instead of the center of the traveling lane of the vehicle M. In this case, the risk area setter 142 further determines whether the pedestrian is approaching or away from the vehicle M when the pedestrian has passed the midpoint of the pedestrian crossing CW, and performs switching control of making the risk area smaller when the pedestrian is away from the vehicle M. As a result, it possible to set an appropriate risk area according to road conditions and the position of a pedestrian. The middle point of the pedestrian crossing CW is likely to be a position between a lane that can travel in the same direction as the traveling lane of the vehicle M and the opposite lane. Therefore, according to the second switching control, it is possible to suppress performing control of excessive deceleration, stop, avoidance, or the like on a pedestrian passing through the opposite lane of the traveling lane of the vehicle M.

<Third Switching Control>

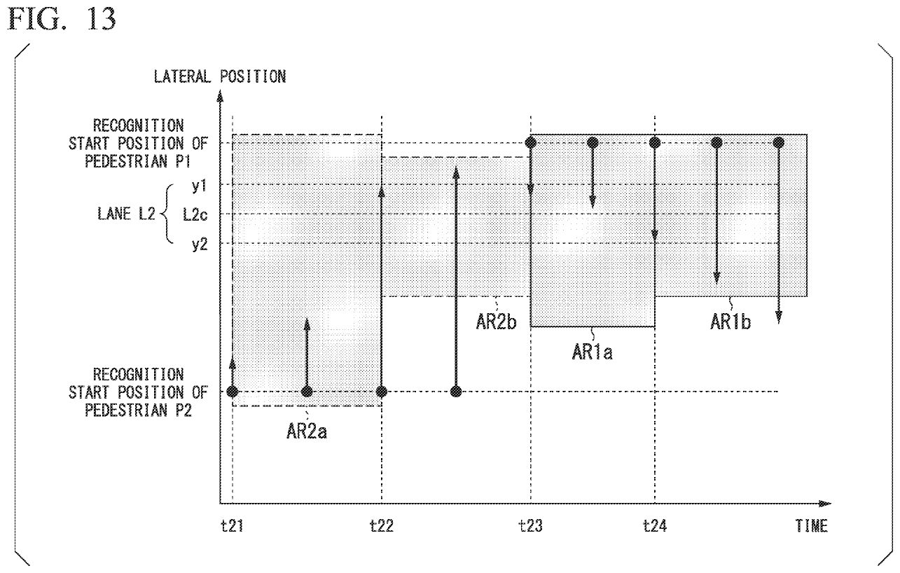

FIG. 13 is a diagram for describing third switching control of a risk area. FIG. 13 shows the switching control of a risk area when the pedestrians P1 and P2 pass through the pedestrian crossing CW at different times as compared with FIG. 12. In the example of FIG. 13, the pedestrian P1 crosses the road R1 from a left side of the vehicle M through the pedestrian crossing, and the pedestrian P2 crosses the road R1 from a right side of the vehicle M through the pedestrian crossing CW. In the example of FIG. 13, current positions and traveling directions (moving directions) of the pedestrians P1 and P2 are shown. Points shown in FIG. 13 indicate positions where the pedestrian P1 and P2 are first recognized by the traffic participant recognizer 132, and arrows indicate the moving direction and the amount of movement of the pedestrians over time. In the example of FIG. 13, it is assumed that time elapses in order of times t21, t22, t23, and t24.

In the third switching control, the risk area setter 142 recognizes the traveling direction and the amount of movement from a position where the pedestrian is first recognized by the traffic participant recognizer 132, and determines whether the pedestrian has exceeded the center L2c of the lane L2 on the basis of a result of the recognition. The determination described above may be made by the situation determiner 144. The risk area setter 142 switches risk areas when it is determined that the pedestrian has exceeded the center L2c of lane L2.

In the example of FIG. 13, the risk area setter 142 sets a second risk area AR2a according to the position of the pedestrian P2 at a time t21 when the pedestrian crossing CW is recognized by the priority section recognizer 134 and the pedestrian P2 is recognized by the traffic participant recognizer 132. Then, at time t22 when it is determined that the pedestrian P2 has crossed the center L2c of the traveling lane L2 on the basis of the traveling direction and the amount of movement of the pedestrian P2 from a point where the pedestrian P2 is recognized, the risk area setter 142 switches to a second risk area AR2b smaller than the current risk area.

In the example of FIG. 13, when the pedestrian P1 is recognized by the traffic participant recognizer 132 at a time t23, the risk area setter 142 sets the first risk area AR1a for the pedestrian P1. In this case, the risk area setter 142 sets the first risk area AR1a, which is larger than the current second risk area AR2b.

At a time t24, when it is determined that the pedestrian P1 has exceeded the center L2c of the traveling lane L2 on the basis of the traveling direction and the amount of movement of the pedestrian P1, the risk area setter 142 switches to the first risk area AR1b, which is smaller than the current risk area.

According to the third switching control described above, the risk area is variably set for each pedestrian according to the position, traveling direction, and the amount of movement of the pedestrian, thereby more appropriate driving control according to the situation of the pedestrian can be executed.

<Fourth Switching Control>

Fourth switching control is to switch risk areas (a first risk area, a second risk area) according to the position of the vehicle M. In the fourth switching control, the risk area setter 142 determines whether there has been a lane change or the like of the vehicle M after a risk area is set, and, when there has been a lane change, it resets a risk area based on a lane in which the vehicle M travels after the lane change. According to the fourth switching control described above, it is possible to set a more appropriate risk area according to the position of the vehicle M.

Each of the first to fourth switching controls described above may be combined with another switching control. Each of the first to fourth switching controls may adjust a size of a risk area according to the speed VM of the vehicle M and a speed of a pedestrian. In this case, as one or both of the speed VM of the vehicle M and the speed of a pedestrian increases, the size of a reference risk area is adjusted to be larger. As a result, it is possible to avoid contact between the vehicle M and the pedestrian more safely.

In the risk area setting described above, when the pedestrian stops, the traveling direction, the amount of movement, or the like may not be recognized. For this reason, the risk area setter 142 may not switch the risk area until a predetermined amount of movement or above, the traveling direction, or the like can be recognized.

[Processing Flow]

Next, a flow of processing executed by the automated driving control device 100 of the embodiment will be described. In the following description, in the processing executed by the automated driving control device 100, driving control processing of the vehicle M based on a risk area set by the recognition of a traffic participant and a priority section will be mainly described. Processing of this flowchart may be repeatedly executed, for example, at a predetermined timing.

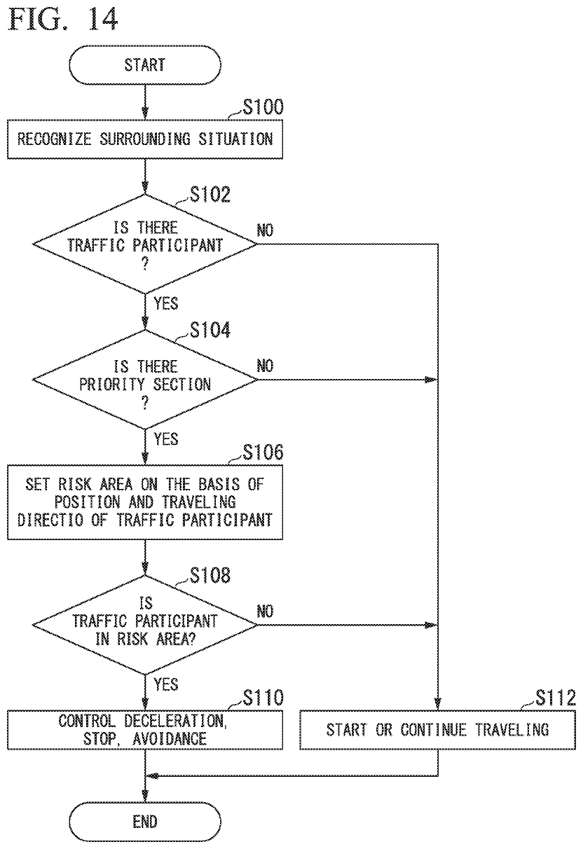

FIG. 14 is a flowchart which shows an example of a flow of the driving control processing executed by the automated driving control device 100. In the example of FIG. 14, it is assumed that automated driving is executed for the vehicle M. In the example of FIG. 14, the recognizer 130 recognizes a surrounding situation of the vehicle M (step S100). In the processing of step S100, at least processing of recognizing, by the traffic participant recognizer 132, a traffic participant who is present in front of the vehicle M and within the first predetermined distance from the vehicle M, and process of recognizing, by the priority section recognizer 134, a priority section that is present in the traveling direction of the vehicle M and within the second predetermined distance from the vehicle M are performed.

Next, the risk area setter 142 determines whether a traffic participant is present within the first predetermined distance in front of the vehicle M (step S102). When it is determined that a traffic participant is present, the risk area setter 142 determines whether a priority section (for example, pedestrian crossing) is present within the second predetermined distance in the traveling direction of the vehicle M (step S104). If it is determined that a priority section is present, the risk area setter 142 sets a risk area on the basis of the position and the traveling direction of the traffic participant (step S106).

Next, the situation determiner 144 determines whether the traffic participant is present in the risk area (step S108). When it is determined that the traffic participant is in the risk area, the travel controller 146 executes one or both of speed control such as decelerating and stopping the vehicle M, and steering control for avoiding contact with the traffic participant (step S110). In the processing of step S108, when it is determined that the traffic participant is not present in the risk area, the travel controller 146 starts traveling of the vehicle M when the vehicle M is stopped, and causes the vehicle M to continue traveling when the vehicle M is traveling (step S112). Even when it is determined in the processing of step S102 that a traffic participant is not present, or when it is determined in the processing of step S104 that a priority section is not present, the processing of starting or continuing the traveling of the vehicle M is executed. As a result, the processing of this flowchart ends. In the processing of FIG. 14, the processing of step S102 and step S104 may be performed in reverse order.

According to the embodiment described above, the vehicle control device includes the recognizer 130 that recognizes a surrounding situation of the vehicle M, and driving controllers (the action plan generator 140, the second controller 160) that execute driving control of controlling one or both of speed and steering of the vehicle M on the basis of the surrounding situation recognized by the recognizer 130. The recognizer 130 recognizes a traffic participant present in front of the vehicle M and a traffic participant priority section present in the traveling direction of the vehicle M, and the driving controller sets a risk area for the traffic participant priority section on the basis of the position and traveling direction of the traffic participant, and executes the driving control on the basis of the set risk area and the position of the traffic participant, thereby executing the driving control of the vehicle based on the recognition of the traffic participant more appropriately.

According to the embodiment, more appropriate driving control can be executed when a vehicle passes through a traffic participant priority section such as pedestrian crossing by considering the position and the traveling direction of a traffic participant. According to the embodiment, safer driving control can be performed according to simple processing of recognizing whether there is a traffic participant in a risk area by setting the risk area according to the position and traveling direction of the traffic participant in a priority section in which the traffic participant is highly likely to cross the road. Therefore, the processing can be simplified and processed at high speed, and a processing load on the vehicle system can be reduced.

The embodiments described above can be expressed as follows.

A vehicle control device is configured to include a storage device that has stored a program, and a hardware processor, and the hardware processor executes the program stored in the storage device, thereby recognizing a surrounding situation of a vehicle, executing driving control of controlling one or both of speed and steering of the vehicle on the basis of the recognized surrounding situation, recognizing a traffic participant present in front of the vehicle and a traffic participant priority section present in a traveling direction of the vehicle from the surrounding situation of the vehicle, setting a risk area for the traffic participant priority section on the basis of a position and traveling direction of the traffic participant, and executing the driving control based on the set risk area and the position of the traffic participant.

Although a mode for carrying out the present invention has been described above using the embodiment, the present invention is not limited to the embodiment, and various modifications and substitutions can be made within a range not departing from the gist of the present invention.

What is claimed is:

1. A vehicle control device comprising:
a recognizer configured to recognize a surrounding situation of a vehicle; and
a driving controller configured to execute driving control of controlling one or both of a speed and steering of the vehicle on the basis of the surrounding situation recognized by the recognizer,
wherein the recognizer recognizes a traffic participant present in front of the vehicle and a traffic participant priority section present in a traveling direction of the vehicle, and
the driving controller sets a risk area for the traffic participant priority section on the basis of a position and a traveling direction of the traffic participant, and executes the driving control based on the set risk area and the position of the traffic participant.

2. The vehicle control device according to claim 1,
wherein, when a distance between the vehicle and the traffic participant priority section is within a predetermined distance and there is a traffic participant in the risk area, the driving controller executes the driving control including steering control for decelerating the vehicle, stopping the vehicle, or causing the vehicle to avoid contact with the traffic participant.

3. The vehicle control device according to claim 1,
wherein the traffic participant priority section includes a pedestrian crossing, and
the driving controller sets different risk areas when the traffic participant enters the pedestrian crossing from a lane side where the traffic participant can travel in the same direction as the traveling direction of the vehicle and when the traffic participant enters the pedestrian crossing from an opposite lane side of the lane where the traffic participant can travel in the same direction.

4. The vehicle control device according to claim 1,
wherein the traffic participant priority section includes a pedestrian crossing, and
the driving controller sets an area including an area from an end of the pedestrian crossing on a side where the traffic participant enters to a position beyond a traveling lane of the vehicle as the risk area.

5. The vehicle control device according to claim 1,
wherein the driving controller switches a risk area on the basis of the position of the traffic participant while the traffic participant is moving in the traffic participant priority section.

6. The vehicle control device according to claim 5,
wherein the driving controller switches the risk area when the traffic participant is present in the traffic participant priority section and the traffic participant crosses a center of the traveling lane of the vehicle.

7. A vehicle control method comprising, by a computer:
recognizing a surrounding situation of a vehicle;
executing driving control of controlling one or both of a speed and steering of the vehicle on the basis of the recognized surrounding situation;
recognizing a traffic participant present in front of the vehicle and a traffic participant priority section present in a traveling direction of the vehicle from the surrounding situation of the vehicle;
setting a risk area for the traffic participant priority section on the basis of a position and a traveling direction of the traffic participant; and
executing the driving control based on the set risk area and the position of the traffic participant.

8. A computer readable non-transitory storage medium that has stored a program causing a computer to execute
recognizing a surrounding situation of a vehicle,
executing driving control of controlling one or both of a speed and steering of the vehicle on the basis of the recognized surrounding situation,
recognizing a traffic participant present in front of the vehicle and a traffic participant priority section present in a traveling direction of the vehicle from the surrounding situation of the vehicle,
setting a risk area for the traffic participant priority section on the basis of a position and a traveling direction of the traffic participant, and
executing the driving control based on the set risk area and the position of the traffic participant.
